(19) United States
(12) Patent Application Publication
(10) Pub. No.: US 2006/0277324 A1
(43) Pub. Date: Dec. 7, 2006

(54) Apparatus, system, and method for automatically detecting a cable configuration

(76) Inventors: Alfredo Aldereguia, Cary, NC (US); Grace Ann Richter, Chapel Hill, NC (US)

Correspondence Address: KUNZLER & ASSOCIATES, 8 EAST BROADWAY, SUITE 600, SALT LAKE CITY, UT, 84111, US

(21) Appl. No.: 11/143,414

(22) Filed: Jun. 2, 2005

(51) Int. Cl. G06F 3/00

(52) U.S. Cl. 710/1

(57) ABSTRACT

An apparatus, system, and method are disclosed for automatically detecting a cable configuration. The apparatus for automatically detecting a cable configuration is provided with a logic unit containing a plurality of modules configured to functionally execute the necessary steps of storing a unique cable identifier, reading the unique cable identifier stored by a storage module, and communicating cable configuration derived from the unique cable identifier to a remote configuration manager. Beneficially, such an apparatus, system, and method will improve network reliability and significantly reduce configuration troubleshooting time. Additionally, such an apparatus, system, and method may be retrofitted into existing systems without prohibitively increasing costs or adversely affecting performance characteristics of the system.

### BACKGROUND OF THE INVENTION

1. Field of the Invention

This invention relates to high-speed network cabling and more particularly relates to automatically detecting a cable configuration.

2. Description of the Related Art

Systems of networkable devices requiring high-speed interconnection cables are often complex, expensive, and require high reliability. One such system incorporates multiple International Business Machines™ (“IBM”) xSeries™ enterprise servers. The xSeries™ enterprise servers include the x440 and x445 models. Additionally, systems may include peripheral expansion modules also requiring high-speed interconnection cables. One such peripheral expansion module is a Remote Expansion Enclosure (“RXE”) such as the RXE-100™ Peripheral Component Interconnect (“PCI”) expansion module.

Typically the xSeries™ enterprise servers are connected using Symmetric Multi-Processing (“SMP”) cables. The RXE components are typically connected to the system using RXE cables. Additionally, other components may be connected to the system using Small Computer System Interface (“SCSI”) cables or the like. The SMP and RXE cables are capable of transferring 3 GB to 6 GB of data per second. However, high-rate cables are relatively expensive. Additionally, high-rate cables are length and configuration sensitive due to the high data rates. A cable that is too long, or is built in the wrong configuration, may introduce error into the data stream by attenuating the available signal levels, spreading the signal pulses, introducing noise, and the like. These and other reductions of signal to noise ratio and pulse shape caused by the cables may result in increased bit error rates between components of the system.

A typical high-rate data cable includes D-type connectors for connecting to the component. Depending on the number of conductors the size and number of pins in the connector may vary from system to system. Typical sizes for high rate cables include 25 pin, 30 pin, and 50 pin. The cables are provided in a variety of lengths including 10 inches, 1 meter, 2.5 meters, and 3.5 meters. Additionally, the cables may include Electromagnetic Interference (“EMI”) protection to reduce the noise introduced by the cable. EMI protection may include a braid of conductor encasing the signal conductors along the distance of the cable. Additionally, foil or other shielding material may be used at the connector to reduce EMI introduced by the connector. Typically such EMI protective conductors are grounded to the connector. As a result, the EMI protective material and conductors are typically enclosed in a shroud, backshell, heat shrink, or the like.

An xSeries™ enterprise server system can include one or more server chassis. A server chassis can accommodates up to two processing nodes. Typically, each node includes three SMP I/O ports. Currently up to four chassis may be connected in an xSeries™ multi-node system. Therefore, up to twenty-four ports may be connected using SMP high-rate cables. Additionally, peripheral expansion devices such as the RXE-100™ may be connected to the system using RXE high-rate cables. The server chassis may be connected to a configuration manager such as IBM Remote Supervisor™. In one embodiment, the server chassis are connected to the configuration manager using RXE high-rate data cables, Ethernet cables, or the like.

Operation of networked servers such as the xSeries™ servers may be highly sensitive to cable length, configuration, and connection. Consequently, configuration errors may arise when a server is cabled incorrectly, or when a connector is not completely connected to the server. This type of configuration error may be time consuming, costly, and otherwise difficult to detect and remedy.

From the foregoing discussion, it should be apparent that a need exists for an apparatus, system, and method that automatically detect a cable configuration. Beneficially, such an apparatus, system, and method will improve network reliability and significantly reduce configuration troubleshooting time. Additionally, such an apparatus, system, and method may be retrofitted into existing systems without prohibitively increasing costs or adversely affecting performance characteristics of the system.

### SUMMARY OF THE INVENTION

The present invention has been developed in response to the present state of the art, and in particular, in response to the problems and needs in the art that have not yet been fully solved by currently available cabling solutions. Accordingly, the present invention has been developed to provide an apparatus, system, and method for automatically detecting a cable configuration that overcome many or all of the above-discussed shortcomings in the art.

The apparatus for automatically detecting a cable configuration is provided with a logic unit containing a plurality of modules configured to functionally execute the necessary steps of storing a unique cable identifier, reading the unique cable identifier stored by a storage module, and communicating cable configuration derived from the unique cable identifier to a remote configuration manager. These modules in the described embodiments include a storage module, a reader module, and a configuration module.

In one embodiment, the apparatus further comprises a connector configured to couple the reader module and the storage module in data communication. The storage module may further comprise nonvolatile memory for continuous storage of the unique cable identifier. In one embodiment, the unique cable identifier includes cable information selected from the group consisting of a cable serial number, a cable revision number, a cable end identifier, a cable length, a cable gauge, a number of conductors, a connector type, a cable type, a cable manufacturer, a cable manufacture date, and an operational characteristic.

Additionally, the reader module may further comprise a detection module configured to detect a cable connection. In one embodiment, the reader module is further configured to communicate with the storage device in accordance with the Inter-IC (“I2C”) bus data communication standard.

In one further embodiment, the configuration module further comprises an arbitration module configured to arrange communication with the remote configuration manager in turn according to an off-line arbitration arrangement between a plurality of configuration modules. Additionally, the configuration manager may further comprise an error module configured to recognize a miscabling event and generate an error message in response to the miscabling event.

In another embodiment, the apparatus for detecting a cable configuration is provided with a logic unit containing a plurality of modules configured to functionally execute the necessary steps of storing a unique cable identifier, receiving a request for the unique cable identifier, and transmitting the unique cable identifier on a data connection. These modules include a memory module, a receiving module, and a responding module.

A system of the present invention is also presented for automatically detecting a cable configuration. In one embodiment, the system includes a cable configured to conduct a signal, a networked component containing a reader module, a storage module coupled to the cable and configured to store a unique cable identifier, a reader module contained by the networked component and operationally coupled to the storage module, wherein the storage module is configured to read the unique cable identifier stored by the storage module, and a configuration module configured to communicate cable configuration information derived from the unique cable identifier to a remote configuration manager.

The system may further include a configuration manager configured to obtain configuration information from a plurality of configuration modules. In one embodiment, the configuration manager if further configured to generate a cable connection topology map form the configuration information. Additionally, the configuration manager may be configured to manage a communication arbitration arrangement for sequencing communication between the configuration manager and the configuration modules. The configuration manager may be further configured to recognize a system miscabling event and generate an error message in response to the system miscabling event.

A method of the present invention is also presented for automatically detecting a cable configuration. The method in the disclosed embodiments substantially includes the steps necessary to carry out the functions presented above with respect to the operation of the described apparatus and system. In one embodiment, the steps include storing a unique cable identifier in a storage module coupled to a cable, reading the unique cable identifier stored in the storage module, and communicating configuration information derived from the unique cable identifier to a remote configuration manager.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for automatically detecting a cable configuration;

FIG. 2 is a schematic block diagram illustrating one embodiment of an apparatus for automatically detecting a cable configuration;

FIG. 3 is a detailed schematic block diagram illustrating one embodiment of an apparatus for automatically detecting a cable configuration;

FIG. 4 is a schematic block diagram illustrating one embodiment of a cable with an attached storage module;

FIG. 5 is a planar view illustration of one embodiment of a high-rate data cable configuration incorporating the storage module in accordance with the present invention;

FIG. 6A is a schematic block diagram illustrating one embodiment of an xSeries™ Enterprise Server configuration;

FIG. 6B is a rear view illustration of one embodiment of a system of the present invention incorporating xSeries™ Enterprise Servers;

FIG. 7 is a rear view illustration of one embodiment of a system of the present invention incorporating xSeries™ Enterprise Servers and a remote configuration manager;

FIG. 8 is a schematic flow chart diagram illustrating one embodiment of a method for automatically detecting a cable configuration;

FIG. 9 is a detailed schematic flow chart diagram illustrating one embodiment of a method for automatically detecting a cable configuration.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

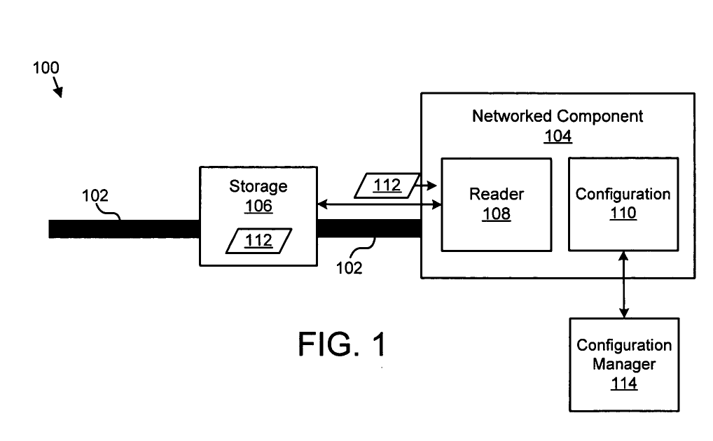

FIG. 1 depicts one embodiment of a system 100 for automatically detecting a cable configuration. In one embodiment, the system 100 includes a cable 102, a networked component 104, a storage module 106, a reader module 108, and a configuration module 110. The storage module 106 may be coupled to the cable 102. Additionally, the reader module 108 and the configuration module 110 may be contained by the networked component 104.

In one embodiment, the cable 102 is configured to conduct data signals. Such a cable may include multiple conductors for conducting the data signals. The conductors may comprise copper, copper alloy, or other conductive metal or metal alloy. In addition, the conductors may be insulated and encased in a protective outer layer. One example a cable 402 is an SMP high-rate data cable. Other examples include RXE data cables, SCSI data cables, fiber optic cables, and the like.

The networked component 104 may contain a reader module 108 and a configuration module 110. In addition, the networked component may route, store, process, or otherwise operate on data transmitted to the component 104 via the cable 102. On example of a networked component is an IBM xSeries™ enterprise server such as the x440 or the x445 model servers. Alternatively, the networked component may include a peripheral scalability module such as an RXE-100™ PCI extension module, a disk storage array, or the like.

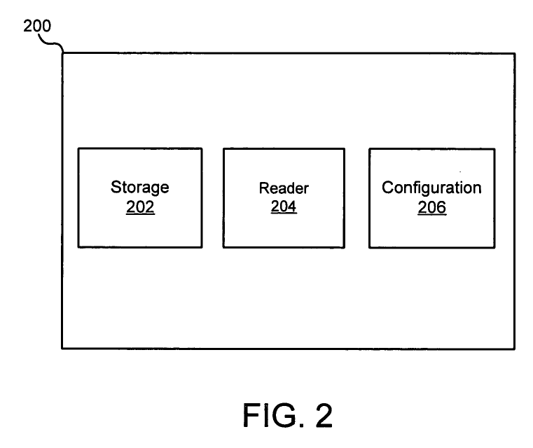

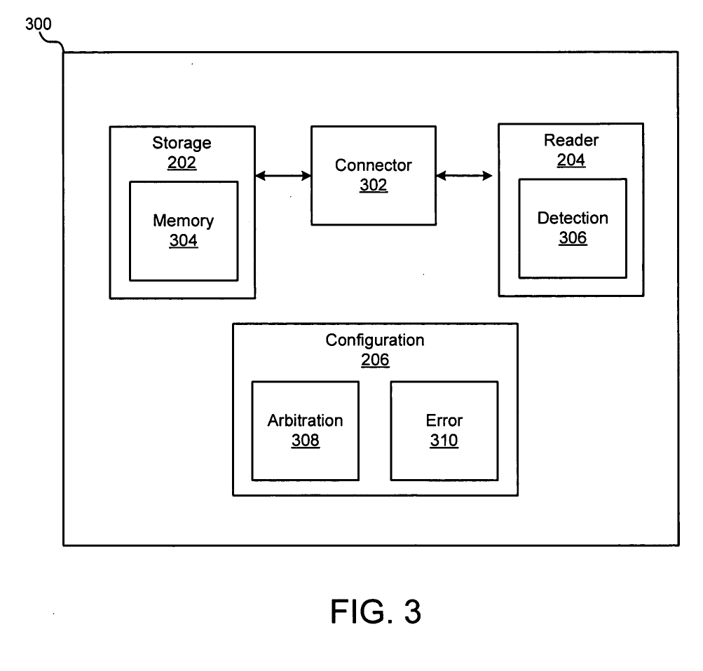

In one embodiment, the storage module 106 is coupled to the cable 102 and configured to store a unique cable identifier 112. The reader module 108 is contained by the networked component 104 and configured to read the unique cable identifier 112 stored by the storage module 106. Additionally, the networked component 104 may contain a configuration module 110 configured to communicate cable configuration information derived from the unique cable identifier 112 to a remote configuration manager 114. The storage module 106, reader module 108, and configuration module 110 are described in further detail with relation to FIG. 2 and FIG. 3.

The unique cable identifier 112 may include cable information specific to the particular cable to be identified. In one embodiment, the cable information includes one or more of a cable serial number, a cable revision number, a cable end identifier, a cable length, a cable gauge, a number of conductors, a connector type, a cable type, a cable manufacturer, a cable manufacture date, and an operational characteristic of the cable. Examples of operational characteristics may include the maximum data rate, frequency band, and power levels handled by the cable 102. Additionally, operational characteristics may include the noise or signal attenuation introduced by the cable.

In one embodiment, the remote configuration manager 114 is configured to collect cable configuration information for a system 100 of networked components 104. The configuration manager 114 may obtain the cable configuration information from the configuration module 110 of the networked components 104. Additionally, the configuration manager 114 may manage a communication arbitration arrangement for sequencing communication between the configuration manager 114 and the configuration modules 110. The configuration manager 114 may be further configured to generate a cable connection topology map from the configuration information. In one further embodiment, the configuration manager 114 may recognize a system 100 miscabling event and generate an error message for a user in response to the miscabling event. One example of a configuration manager is an IBM Remote Supervisor™. Remote Supervisor™ may manage other aspects of a system 100 of networked components 104 in addition to managing the cable configuration.

FIG. 2 illustrates one embodiment of an apparatus 200 for automatically detecting a cable configuration. In one embodiment, the apparatus 200 includes a storage module 202, a reader module 204, and a configuration module 206. These modules in the described embodiments may be substantially similar to the corresponding modules of the system 100. In one embodiment, these modules are configured to carry out the necessary steps of storing a unique cable identifier 112, reading the unique cable identifier 112 stored on the storage module 202, and communicating cable configuration information derived from the unique cable identifier 112 to a remote configuration manager 114.

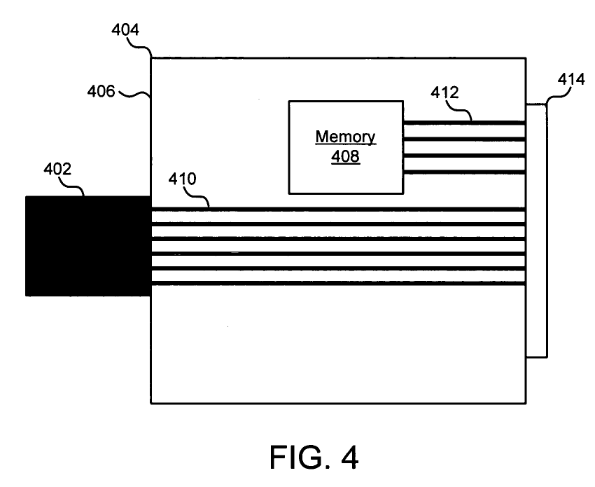

In one embodiment, the storage module 202 stores a unique cable identifier 112. The unique cable identifier 112 may be stored in the storage module by a cable manufacture at the time of manufacture. Alternatively, the unique cable identifier 112 may be stored, modified, erased, or the like by a user or technician. The storage module 202 may include a nonvolatile memory device. The storage module is described in further detail in the description of FIG. 3 and FIG. 4.

The reader module 204 may be operationally coupled with the storage module 202 and configured to read the unique cable identifier 112 stored on the storage module 202. Operationally coupled may include a wired connection, a wireless connection, or a magnetic field connection. Additionally, operationally coupled may include configuration of compatible communication protocols and the like. For example, the reader module 204 may communicate with the storage module 202 on an Inter Integrated Circuit (“I2C”) bus with an associated data protocol. A reader module 204 may include input and output interfaces, as well as an I/O controller for issuing communication commands, and processing results. In one embodiment, the reader module 204 is configured to detect a cable connection.

In one embodiment, the configuration module 206 is configured to communicate cable configuration information derived from the unique cable identifier 112 to a remote configuration manager 114. The configuration module 206 may derive the configuration information from the unique cable identifier 112 read by the reader module 204. For example, configuration information may include the serial number and end identifier of the cable 102 connected to the networked component 104, and that the connection is actively passing data.

FIG. 3 is a detailed embodiment of an apparatus 300 for automatically detecting a cable configuration. The apparatus 300 includes the storage module 202, reader module 204, and configuration module 206 as described above. Additionally, the apparatus 300 includes a connector 302, a memory module 304, a detection module 306, an arbitration module 308, and an error module 310.

In one embodiment, the connector 302 is configured to couple the reader module 204 and the storage module 202 in data communication. The connector 302 may include one or more conductors coupled to input/output pins of the memory module 302 of the storage module 202 on one end, and the reader module 202 on the other end. For example, the connector 302 may include a data signal connection, a clock signal connection, a power connection, and a ground connection. In one embodiment, the connector 302 is a D-type connector. Alternatively, the connector may include a round mil-spec connector, a fiber optic connector, a wireless connection, or the like.

In one embodiment, the storage module 202 includes a memory module 304. In one embodiment, the memory module 304 is configured to store the unique cable identifier 112. The memory module 304 may be a nonvolatile memory device such as a PROM, EEPROM, Flash memory, magnetic disk, or the like. The nonvolatile memory 302 may continuously store the unique cable identifier 112 when the cable is not connected to a power source.

The reader module 204 may include a detection module 306 configured to detect a new cable connection. The detection module 306 may detect the cable connection by periodically checking the 12C data bus lines for the presence of the storage module 202. Alternatively, the detection module 306 may detect incoming signals on the port associated with the cable 102. In another alternative embodiment, the detection module 306 may include an open electrical contact that is shorted when a connector is inserted, or a like switched mechanism for detecting the presence of the cable 102 or connector 302.

In one embodiment, the configuration module 206 includes an arbitration module 308. The arbitration module 308 is configured, in one embodiment, to arrange communication with the remote configuration manager 114 in turn according to an off-line arbitration arrangement between a plurality of configuration modules 206. For example, multiple xSeries™ servers 104 may be connected to a remote configuration manager 114. In order to avoid conflicts in communicating the configuration information to the remote configuration manager 114, the arbitration modules 308 of the servers 104 may determine an order of communication with the configuration manager 114. In certain embodiments, the arbitration communication is carried out on a separate off-line communication connection between the servers 104 and the configuration manager 114.

In one embodiment, the configuration module 206 may additionally include an error module 310. The error module 310 may recognize a miscabling event based on the unique cable identifier 112 from a connected cable 102. For example, the error module 310 may detect that a 3.5 meter cable 102 is connected to the networked component 104 when a 10 inch cable is specified. In response to the error, the error module 310 may generate an error message for a user. The error message may include a logged event in a troubleshooting log, an error dialogue box on a display screen, an email, a pager message, an audible alarm, or the like. In certain embodiments, the error module 310 may operate independent of the configuration manager 114. Alternatively, the error module 310 may coordinate error detection and notification with the remote configuration manager 114.

FIG. 4 illustrates one embodiment of a cable 402 with an attached storage module 404. In one embodiment, the storage module 404 includes a structural support card 406 and a memory module 408. Additionally, the structural support card 406 may provide a means for passing through signals from one or more conductors 410 from the cable 402. The, structural support card 406 may additionally provide means for 412 connecting the memory module 408 to a reader module 108. In one embodiment, the storage module 404 may be coupled to a connector 414.

In one embodiment, the structural support card 406 may include a printed circuit card. The printed circuit card 406 may comprise a polymer substrate with a conductive metal layer deposited or adhesively attached thereon. Alternatively, the printed circuit card 406 may comprise a metallic substrate with an insulation layer deposited or adhesively attached thereon. In certain embodiments, the insulation layer may be etched or removed to expose portions of the metallic layer. In one embodiment, components of the cable 402, the storage module 404, and the connector 414 may be coupled to the card 406 with solder, adhesive, or the like.

The memory module 408 may be coupled to the card 406. In one embodiment, the memory module 408 comprises a nonvolatile memory chip such as a Programmable Read-Only Memory (“PROM”), Electrically Erasable PROM (“EEPROM”), flash memory, or the like. Alternatively, the memory module 408 may include a magnetic memory device, an optically readable memory device, the storage portion of a Radio Frequency Identification (“RFID”) unit, or the like.

In one embodiment, the conductors 410 are supported by the card 406. The conductors 410 may be soldered to the card 406 to ensure structural support. Alternatively, the conductors 410 may be clamped or otherwise mechanically connected to the card 406. In another embodiment, the conductors 410 are connected to contacts of printed conductor paths on the card 406.

The storage module 404 may additionally include means 412 for connecting the memory module 408 to the reader module 108. In one embodiment, the connecting means 412 includes one or more conductors coupled to input/output pins of the memory module 408 on one end, and a connector 414 or the reader module 108 on the other end. For example, the connecting means 412 may include a data signal connection, a clock signal connection, a power connection, and a ground connection. Alternatively, the connecting means 412 may include a wireless coupling such as electromagnetic waves, light, magnetic flux, or the like. Additionally, the connecting means 412 may include an input/output circuit. The input/output circuit may include one or more filter circuits for blocking transient signals and the like. Additionally, the input/output circuit may include hardware components such as capacitors, inductors, resistors, or transistors. Alternatively, the connecting means 412 may include digital logic components such as signal buffers, inverter gates, or the like.

In one embodiment, the connector 414 is configured to couple the reader module 108 and the storage module 404 in data communication. For example, the connector 414 may contain electrical contact pins coupled to the connecting means 412 for connecting with a corresponding connecting means associated with the reader module 108. In one embodiment, the connector 414 is a D-configuration data connector. Alternatively, the connector 414 may include other types of connectors such circular configuration data cables as specified by U.S. military standards, optical connectors, coaxial connectors, and the like.

In certain embodiments, the connector 414 may include an attached backshell, shroud, or the like to protect cable connections at the connector and provide a means for grounding the EMI protective layers. In certain embodiments, the storage module 404 may be contained within the backshell or shroud of the connector 414.

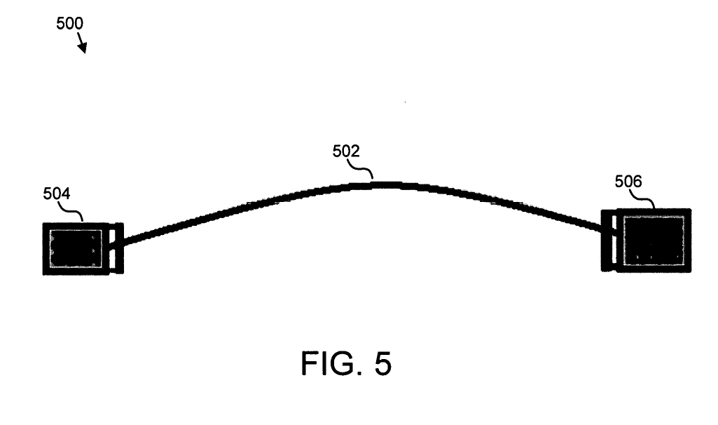

FIG. 5 illustrates one embodiment of a high-rate data cable 500 incorporating the storage module 404. In the depicted embodiment, the high-rate data cable 500 includes a signal conducting cable portion 502, a first storage module 504 and a second storage module 506.

The first storage module 504 and the second storage module 506 may be configured in substantially the same manner as the storage module 404 depicted in FIG. 4. The unique identifier 112 stored in the memory module 408 may include an end identifier for indicating whether the first end or the second end of the cable is connected to the networked component 104.

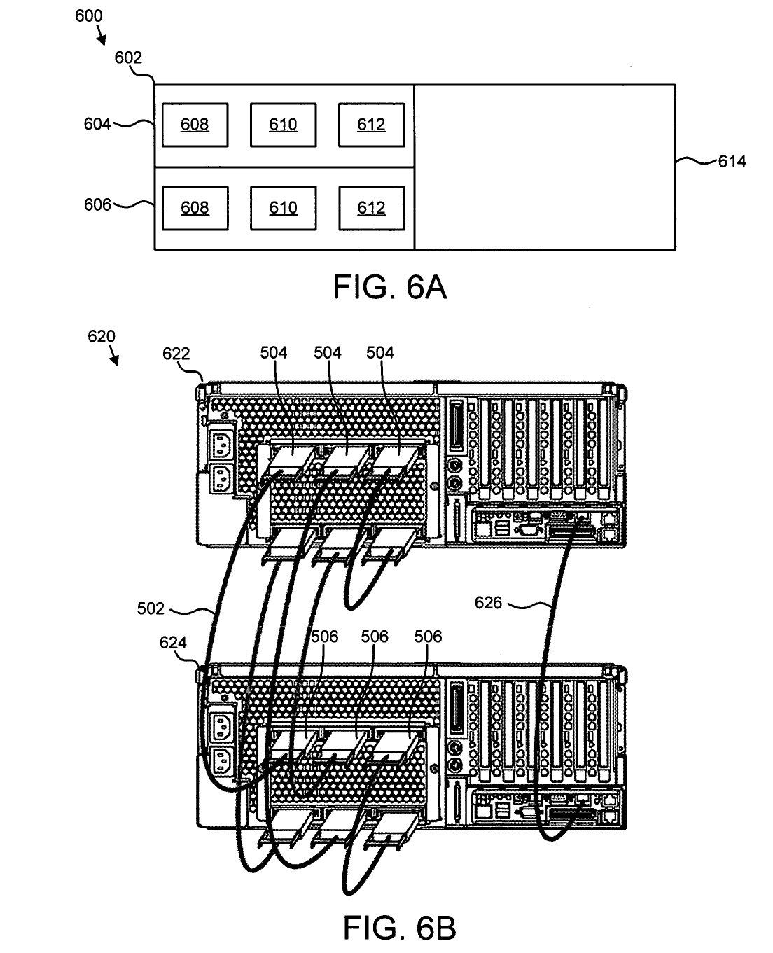

FIG. 6A is a schematic block diagram of an xSeries™ enterprise server 600. In one embodiment, the xSeries™ server 600 includes a chassis 602 for providing power and structural support for one or two server modules 604, 606. The chassis 602 is typically separated into two parts. The first contains the first server module 604 and the second server module 606. The second portion 614 houses the power supply, and I/O controls and connectors.

An xSeries™ server 600 such as an x445 includes SMP ports for creating an interconnection network between two or more modules 604,606. Each module may include a first SMP port 608, a second SMP port 610, and a third SMP port 612. The set of three SMP ports are useful in creating a highly available redundant connection between the modules 604, 606.

FIG. 6B illustrates one example of an xSeries™ server network 620. In the depicted example, the network 620 includes a first chassis 622 and a second chassis 624. The first chassis 622 and the second chassis 624 include a first server module 604 and a second server module 606. Each server module 604, 606 includes a first SMP port 608, a second SMP port 610, and a third SMP port 612. The server modules 604,606 are connected using high-rate data cables 500.

The cables 500 include a cable conductor 502, a first storage module 504, and a second storage module 506. The cables 500 may include a substantially similar configuration to those described with relation to FIG. 5. Additionally, the system 620 may include an Ethernet or other off-line connection 626 for arbitration, and control of configuration management communications.

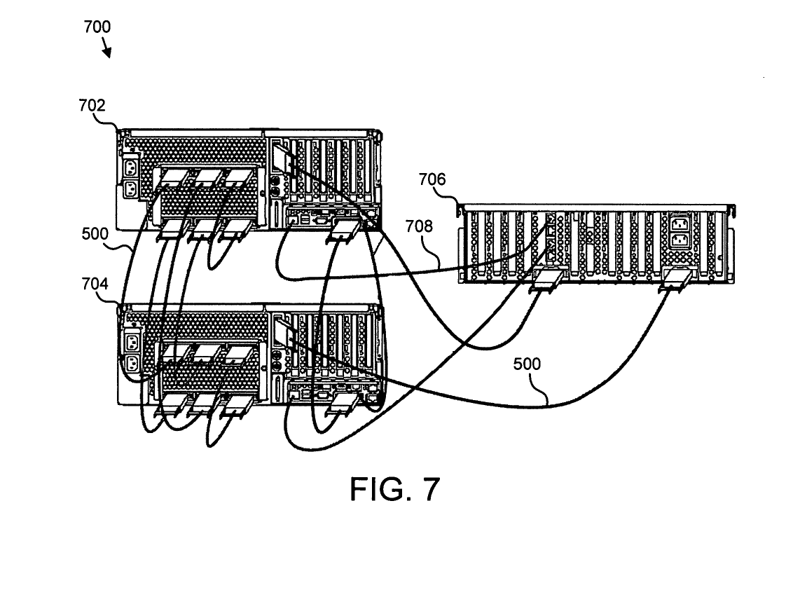

FIG. 7 is a rear view illustration of one embodiment of a system 700 including xSeries™ servers as described with relation to FIG. 6, and a remote configuration manager 706. In this example, the system 700 includes a first server chassis 702, a second server chassis 704, and a remote configuration manager 706. The server modules 604, 606 of the first server chassis 702 and the second server chassis 704 are connected using high-rate data cables 500 in accordance with the present invention.

Additionally, the first server chassis 702 and the second server chassis 704 are connected to the remote configuration manager 706 using off-line communication cables such as Ethernet cables 708 and high-rate data cables 500. The remote configuration manager 706 may comprise IBM Remote Supervisor™ or IBM Director™. The configuration manager 706 may generate a connection topology map of the connections between the first server chassis 702 and the second server chassis 704 using cable configuration information derived from the unique cable identifier 112 stored in the storage module 404 of the high-rate data cables 500. Additionally, the configuration manager 706 may manage communication arbitration between the first server chassis 702 and the second server chassis 704.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

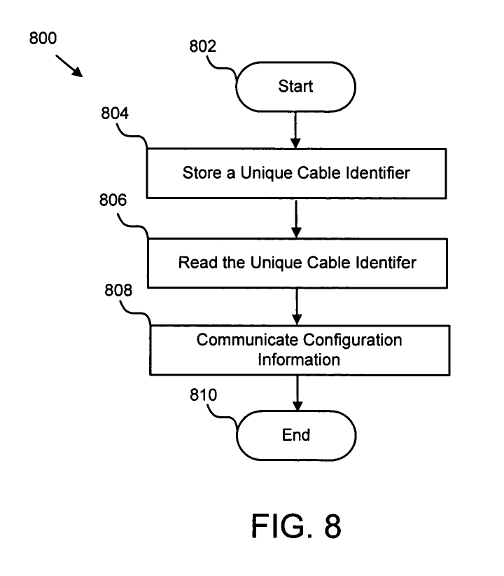

FIG. 8 illustrates one embodiment of a method 800 for automatically detecting a cable configuration. The method starts 802 by storing 804 a unique cable identifier 112 in the storage module 202. The reader module 204 reads 806 the unique cable identifier 112 stored by the storage module 202. The communication module 206 then communicates 808 cable configuration information derived from the unique cable identifier 112 to a remote configuration manager 114, and the method ends 810.

For example, a unique cable identifier containing the serial number, revision number, length, and end identifier may be stored 804 in the storage module 106 associated with an SMP cable 102. A reader module 108 contained by an xSeries™ 445 networked server 104 may read 806 the unique cable identifier 112. The communication module 110 may communicate 808 configuration information, including a mapping of the cable/port connection, to a remote configuration manager 114.

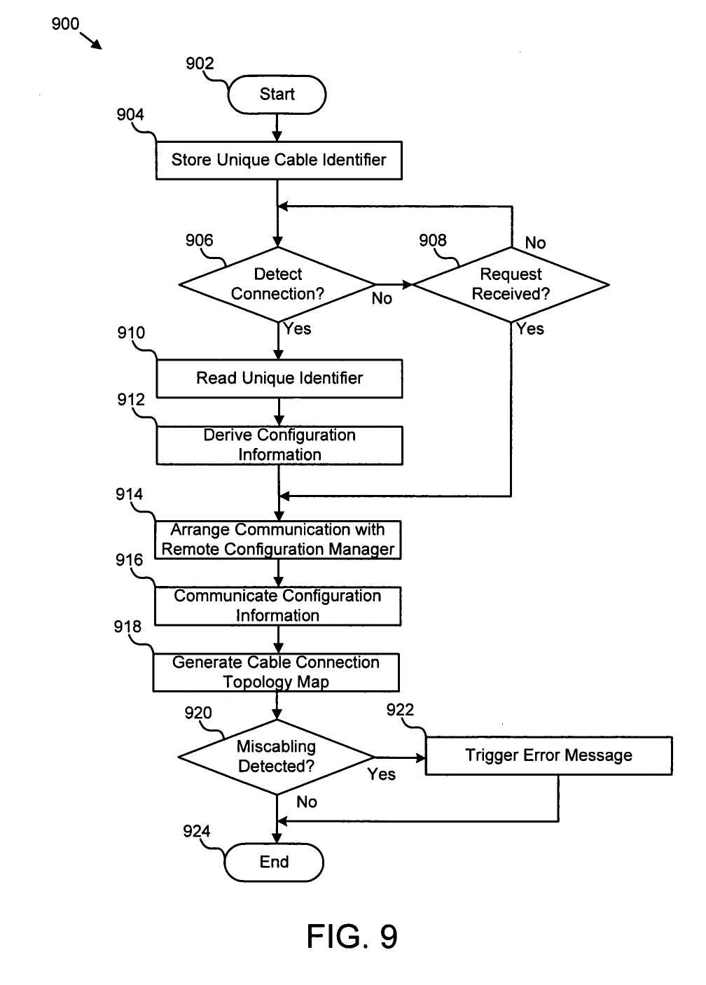

FIG. 9 illustrates one embodiment of a detailed method 900 for automatically detecting a cable configuration. In one embodiment, the method 900 starts 902 by storing 904 a unique cable identifier 112 in a storage module 202. If the connection module 306 has not detected 906 a cable connection and no request for configuration information has been received 908 by the configuration module 206, the detection module 306 and the configuration module 206 continue to check 906, 908 for either event.

If a cable connection is detected 906 by the detection module 306, the reader module 204 may read 910 the unique cable identifier 112 stored on the storage module 202 and derive 912 configuration information from the unique cable identifier 112. The arbitration module 308 may then arrange 914 communication with the remote configuration manager 114. If a cable connection has not been detected 906, but a request for configuration information has been received 908 by the configuration module 206, the reader module 204 is unable to read 910 or derive 912 the configuration information. In this situation, the arbitration module 308 arranges 914 communication with the remote configuration manager 114 and may indicate that no cable connection has been established.

The configuration module 206 may then communicate 916 the configuration information to the remote configuration manager 114. The remote configuration manager 114 may generate 918 a cable connection topology map from cable configuration information received from multiple networked components 104. The remote configuration manager 114 may then analyze the topology map and detect 920 miscabled or missing connections. If a miscabling is detected 920, an error message may be triggered 922 for a user and the method ends 924. If a miscabling is not detected 920, the method ends 924 without any error.

Beneficially, such an apparatus, system, and method would improve network reliability and significantly reduce configuration troubleshooting time. Additionally, such an apparatus, system, and method may be retrofitted into existing systems without prohibitively increasing costs or adversely affecting performance characteristics of the system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced with their scope.

What is claimed is:

1. An apparatus for automatically detecting a cable configuration, the apparatus comprising:
a storage module coupled to a cable and configured to store a unique cable identifier;
a reader module operationally coupled with the storage module and configured to read the unique cable identifier stored by the storage module; and
a configuration module configured to communicate cable configuration information derived from the unique cable identifier to a remote configuration manager.

2. The apparatus of claim 1, further comprising a connector configured to couple the reader module with the storage module in data communication.

3. The apparatus of claim 1, wherein the storage module further comprises nonvolatile memory for continuous storage of the unique cable identifier.

4. The apparatus of claim 1, wherein the reader module further comprises a detection module configured to detect a cable connection.

5. The apparatus of claim 1, wherein the reader module is further configured to communicate with the storage device in accordance with the Inter-IC (“I2C”) bus data communication standard.

6. The apparatus of claim 1, wherein the configuration module further comprises an arbitration module configured to arrange communication with the remote configuration manager in turn according to an off-line arbitration arrangement between a plurality of configuration modules.

7. The apparatus of claim 1, wherein the configuration module further comprises an error module configured to recognize a miscabling event and generate an error message in response to the miscabling event.

8. The apparatus of claim 1, wherein the unique identifier includes cable information selected from the group consisting of a cable serial number, a cable revision number, a cable end identifier, a cable length, a cable gauge, a number of conductors, a connector type, a cable type, a cable manufacturer, a cable manufacture date, and an operational characteristic.

9. An apparatus for automatically detecting a cable configuration, the apparatus comprising:
a memory module configured to persistently store a unique cable identifier;
a receiving module configured to receive a request for the unique cable identifier; and
a responding module configured to transmit the unique cable identifier on a data connection.

10. A system for automatically detecting a cable configuration, the system comprising:
a cable configured to conduct a signal;
a networked component containing a reader module;
a storage module coupled to the cable and configured to store a unique cable identifier;
a reader module contained by the networked component and operationally coupled to the storage module, wherein the storage module is configured to read the unique cable identifier stored by the storage module; and
a configuration module configured to communicate cable configuration information derived from the unique cable identifier to a remote configuration manager.

11. The system of claim 10, further comprising a connector configured to couple the reader module and the storage module in data communication.

12. The system of claim 10, wherein the storage module further comprises nonvolatile memory for continuous storage of the unique cable identifier.

13. The system of claim 10, wherein the reader module further comprises a detection module configured to detect a cable connection.

14. The system of claim 10, further comprising a configuration manager configured to obtain configuration information from a plurality of configuration modules.

15. The system of claim 14, wherein the configuration manager is further configured to generate a cable connection topology map from the configuration information.

16. The system of claim 14, wherein the configuration manager is further configure to manage a communication arbitration arrangement for sequencing communication between the configuration manager and the configuration modules.

17. The system of claim 14, wherein the configuration manager is further configured to recognize a system miscabling event and generate an error message in response to the system miscabling event.

18. A signal bearing medium tangibly embodying a program of machine-readable instructions executable by a digital processing apparatus to perform operations for automatically detecting a cable configuration, the operation comprising:
an operation to store a unique cable identifier in a storage module coupled to a cable;
an operation to read the unique cable identifier stored in the storage module; and
an operation to communicate configuration information derived from the unique cable identifier to a remote configuration manager.

19. The signal bearing medium of claim 18, further comprising an operation to detect a cable connection.

20. The signal bearing medium of claim 18, further comprising an operation to use the unique cable identifier to generate cable configuration information.

21. The signal bearing medium of claim 18, further comprising an operation to arrange communication with the remote configuration manager in turn according to an off-line arbitration arrangement between a plurality of configuration modules.

22. The system of claim 21, wherein the configuration manager is further configured to generate a cable connection topology map from the configuration information.

23. The signal bearing medium of claim 18, further comprising an operation to recognize a miscabling event and generate an error message in response to the miscabling event.

24. The signal bearing medium of claim 18, wherein the unique identifier includes cable information selected from the group consisting of a cable serial number, a cable revision number, a cable end identifier, a cable length, a cable gauge, a number of conductors, a connector type, a cable type, a cable manufacturer, a cable manufacture date, and an operational characteristic.

25. A method for automatically detecting a cable configuration, the method comprising:
storing a unique cable identifier in a storage module coupled to a cable;
reading the unique cable identifier stored in the storage module; and
communicating configuration information derived from the unique cable identifier to a remote configuration manager.
